(19) United States
(12) Patent Application Publication
(10) Pub. No.: US 2016/0372089 A1
(43) Pub. Date: Dec. 22, 2016

(54) Electric Guitar with Interchangeable Faceplate and Concealed Fasteners

(71) Applicant: Moniker Guitars LLC, Austin, TX (US)

(72) Inventors: Kevin Michael Tully, Austin, TX (US); Micah Bruce, Austin, TX (US); David Barry, Austin, TX (US)

(73) Assignee: Moniker Guitars LLC, Austin, TX (US)

(21) Appl. No.: 15/185,000

(22) Filed: Jun. 16, 2016

Related U.S. Application Data
(60) Provisional application No. 62/181,025, filed on Jun. 17, 2015.

(51) Int. Cl. G10D 1/08; G10D 3/04; G10D 3/14; G10H 3/18

(52) U.S. Cl. CPC G10D 1/085; G10H 3/18; G10D 3/04; G10D 3/146

(57) ABSTRACT

The present invention allows the user to remove the faceplate of a guitar without the need for tools and to exchange the faceplate for another faceplate which may include different components that will change the sound of the guitar. Additionally, the user may change the faceplate to give the guitar a different look or aesthetic.

### CROSS-REFERENCE TO RELATED APPLICATIONS

This application makes reference to U.S. Prov. App. No. 62/181,025 filed Jun. 17, 2015 which is incorporated by reference in its entirety.

### FIELD OF THE INVENTION

The present invention deals with electric guitars, specifically, an electric guitar with an interchangeable faceplate, pickup, and concealed fasteners.

### BACKGROUND OF THE INVENTION

An electric guitar typically derives its sound from component parts, known as pickups, which are installed in the body of the guitar in one of two ways. The first method is to install the pickups by attaching them directly to the body of the guitar. The second method calls for a flat piece of material (typically plastic, aluminum, etc.) known as a “pickguard,” to which the pickups are attached before the pickguard is then mounted to the face of the guitar body, typically thru the use of screws.

Once either of these methods has been used, the pickups are then wired to other components housed in the body of the guitar including an output jack which transmits the sounds of the guitar or bass to an amplifier. Due to several factors it is difficult, and therefore uncommon, for guitar users to switch the pickguard and pickups on a guitar. Instead many users will own several guitars in order to have the kind of sound and aesthetic variety they desire.

Accordingly, what is needed is an electric guitar with a freely interchangeable faceplate including the electric pickup.

What is also needed is an electric guitar with a freely interchangeable faceplate including the electric pickup that includes hidden fasteners.

What is also needed is a method of using an electric guitar with a freely interchangeable faceplate including the electric pickup.

### SUMMARY OF THE INVENTION

The present invention consists of a detachable faceplate for an electric guitar or bass guitar which allows the user to change the sound and look of the instrument without the need for tools. Typically musicians would own several guitars in order to have a wide variety of sounds and aesthetics available. However the current invention eliminates the need for purchasing multiple guitars.

One embodiment of the present invention includes a detachable faceplate that includes the bridge and pickup and other guitar components attached to it. On the reverse side of the detachable faceplate a multiplicity of faceplate magnets are attached. It is by means of these faceplate magnets that the detachable faceplate is attached to a guitar body.

One embodiment of the present invention includes a guitar body with at least one cavity and a multiplicity of body magnets that the detachable faceplate is attached to.

One embodiment of the present invention is used in the following manner: First, the user selects a suitable detachable faceplate from a series of detachable faceplates. Next, the user removes the strings and faceplate of a guitar equipped with a detachable faceplate. Next, the user places the selected detachable faceplate against the exterior surface of the guitar body such that the electronic components present on the back of the selected detachable faceplate are insinuated in the cavity formed in the front surface of the guitar body and the faceplate magnets on the reverse surface of the detachable faceplate mate with the body magnets in the exterior surface of the guitar body. Next, the user allows the selected detachable faceplate to become mated with the guitar body. Finally, the user replaces the strings on the guitar.

### BRIEF DESCRIPTION OF THE DRAWINGS

FIG. 1 shows the front of the detachable faceplate with cavities containing or exposing the component parts of the guitar.

FIG. 2 illustrates the back of the detachable faceplate showing a plurality of faceplate fasteners embedded in or fastened to it.

FIG. 3 illustrates the front of the guitar body with a plurality of body fasteners embedded in or fastened to it. These are positioned to make contact with the detachable faceplate fasteners when the detachable faceplate is installed. FIG. 3 also illustrates a cavity in the guitar body which will house the component parts contained in the detachable faceplate.

FIG. 4 illustrates a side view of the guitar body containing concealed body fasteners in recessed cavities. FIG. 4 also illustrates a side view of the detachable faceplate showing the concealed faceplate fasteners attached to the rear surface of the detachable faceplate.

FIG. 5 illustrates the front of the detachable faceplate of another embodiment of the invention. A hole is cut into the detachable faceplate where a sound hole would traditionally be located on the top of some electric guitars and serves as the access point for the user to grip and remove the detachable faceplate.

FIG. 6 illustrates another embodiment of the invention in which a guitar body has a recessed lip to receive the detachable faceplate in such a manner that the detachable faceplate sits flush with the top of the outer edge of the guitar body. FIG. 6 also illustrates another embodiment of the invention in which a plurality of cavities are cut in the guitar body to reduce the weight of the guitar

### DETAILED DESCRIPTION OF THE EMBODIMENTS

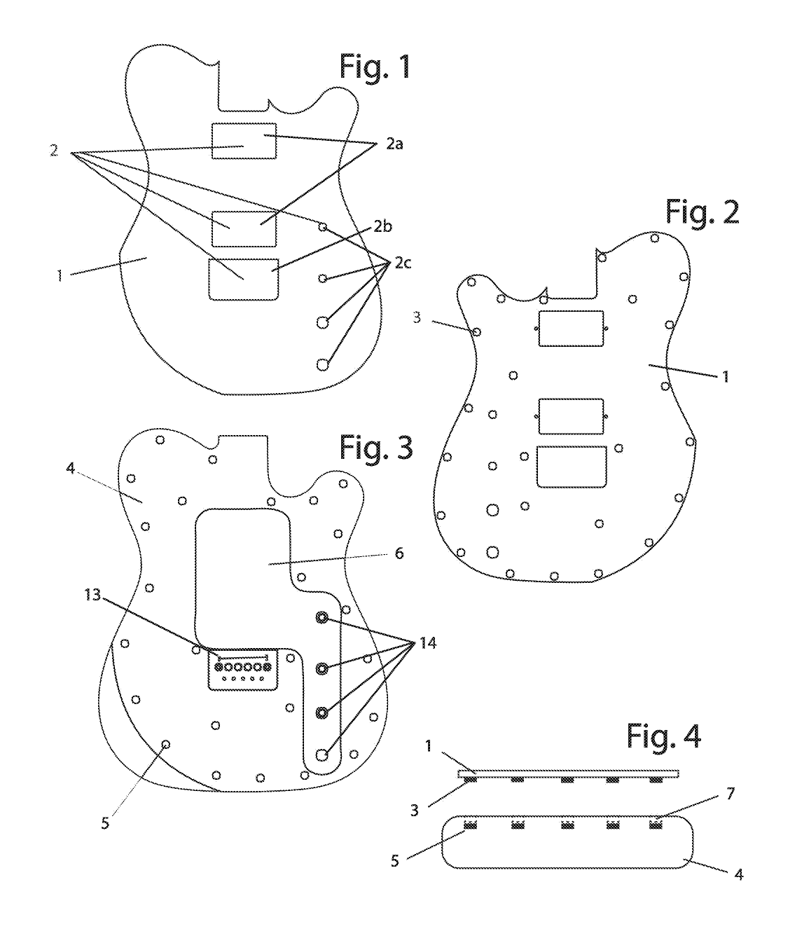

Turning now to FIGS. 1 through 3, the front (exposed surface) and the rear (hidden surface) of detachable faceplate 1 and the front surface of guitar body 4 of one embodiment of the present invention is shown. Detachable faceplate 1 has a multiplicity of holes 2 to which all of the sound components (such as pickups 2a, potentiometers and switches 2c, etc.) may be installed and wired together before being attached to guitar body 4. Detachable faceplate 1 also has hole 2b for bridge 13 to extend through when detachable faceplate 1 is affixed to guitar body 4. Those having skill in the art will recognize that different arrangements of components are possible. For example, bridge 13 may be comprised of two independent elements: a bridge and a tailpiece. Similarly, those having skill in the art will recognize that other components may be installed. For example, bridge 13 may comprise a vibrato or whammy bar.

Detachable faceplate 1 is attached to guitar body 4 by means of concealed fasteners 3 and 5 such that tools are not required to remove and replace the faceplate. One embodiment of the present invention uses faceplate magnets as exemplified by faceplate magnet 3 mounted on the rear (hidden surface) of detachable faceplate 1 to affix detachable faceplate 1 to opposite polarity guitar magnets as exemplified by body magnet 5 on guitar body 4. Other embodiments of the present invention use other means of affixing detachable faceplate 1 to guitar body 4. For example, one embodiment of the present invention uses hook and loop fasteners in lieu of magnets. The present invention requires that the mechanism for attaching detachable faceplate 1 to guitar body 4 does not show through detachable faceplate 1 the way that screw heads appear on a conventional pickguard on a conventional electric guitar. This helps maintain an aesthetic appearance.

A concealed fastener which does not require tools and may be removed by hand is also key in that it allows the user to easily remove the faceplate and replace it with a second faceplate which is comprised of a different surface color, material, or design aesthetic and contains different sound components, giving the guitar different tonal qualities.

Referring now to FIGS. 1 and 3, one embodiment of the present invention calls for cavity 6 in guitar body 4 to be large enough to accommodate the component parts installed in detachable faceplate 1 as well as any alternative component parts which may be installed on additional faceplates. The location in cavity 6 of potentiometers and switches 2c, etc. mounted on detachable face 1 is shown at 14.

Those having skill in the art will recognize that the output jack of the guitar is preferably located along the edge of guitar body 4 and not on detachable faceplate 1. This is because of the physical strain the output cord or transmitter places on the output jack when the output cord or transmitter is removed from the output jack. Accordingly, an electrical interface between the output jack and the components mounted on detachable faceplate 1 must be provided. Such an interface is preferably provided by means of a male-female connector pair mounted between the rear (hidden surface) of detachable faceplate 1 and the lateral side or end of cavity 6 formed in guitar body 4 such that the connector pair is connected when detachable faceplate 1 is attached to guitar body 4 and that the connector pair is disconnected when detachable faceplate 1 is removed from guitar body 4. Preferably, half of the connector pair is located in a fixed location on guitar body 4 such that it is mateable with the other half of the connector mounted on any detachable faceplate 1.

Turning now to FIG. 4 a cross section of detachable faceplate 1 and guitar body 4 is shown. Magnets (as exemplified by faceplate magnet 3) are attached or adhered to the rear (hidden surface) of detachable faceplate 1. Opposite polarity magnets (as exemplified by body magnet 5) are attached or adhered to the front surface of guitar body 4. It will be readily understood that these magnets may be replaced with a non-magnetic ferrous material. Body magnet 5 is inserted into hole or cavity 7 such that no clearance exists between the rear (hidden surface) of detachable faceplate 1 and the front surface of guitar body 4 when the two are connected together.

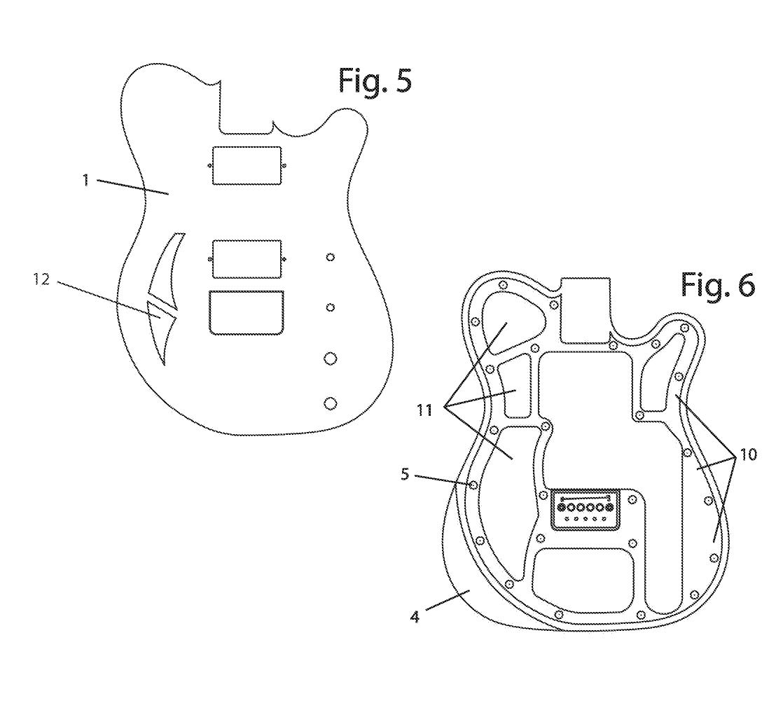

Referring now to FIGS. 5 and 6, one embodiment of detachable faceplate 1 mates into recessed cavity 10 that allows detachable faceplate 1 to sit flush within the face of guitar body 4 eliminating any chance that the user's hand or arm comes in contact with the edge of detachable faceplate 1. In this embodiment, body magnets 5 are arranged in recessed cavity 10. Also, in this embodiment, sound hole 12 is cut in detachable faceplate 1 to give the user an access point for removing the detachable faceplate 1 with the hand. Additional cavities 11 in the guitar body lighten the guitar.

Referring now to FIGS. 1 through 4, this embodiment of the present invention is used in the following manner: First, the user selects a suitable detachable faceplate 1 from a series of detachable faceplates. Next, the user removes the strings and present detachable faceplate 1 of a guitar. Next, the user places selected detachable faceplate 1 against the exterior surface of the guitar body 4 such that the electronic components present on the selected detachable faceplate 1 are insinuated in cavity 6 formed in the front surface of guitar body 4 and the faceplate magnets 3 on the reverse surface of the detachable faceplate 1 are approximated with body magnets 5 mounted in the exterior surface of guitar body 4. Next, the user allows the selected detachable faceplate 1 to become mated with guitar body 4. Finally, the user replaces the strings on guitar body 4.

As discussed supra, the present invention consists of three major parts: 1) The guitar body; 2) The detachable faceplate; and, 3) The concealed fasteners which allow the detachable faceplate to be attached or detached from the guitar body without tools, nor show through the faceplate.

Guitar bodies can be made of many different materials such as wood, resin-cast, plastic, metal, etc. Detachable faceplates can be made of different materials such as plastic, aluminum, wood, etc. Detachable faceplates may feature different colors, prints, patterns, printed graphics, or sound hole shapes. The concealed fasteners may be comprised of magnets, hook and loop materials, or similar substances. Similarly, concealed fasteners may be applied in any form or layout on the rear of the faceplate and front of the guitar body.

It is obvious to those having skill in the art that a faceplate that covers almost the entirety of the front of the guitar may be used to change the instrument's color without needing to resort to the tedious process of painting or staining the guitar. Painting and staining can be difficult and labor intensive whereas connecting a faceplate requires little skill. Further, the present invention allows for more units to be produced in the same amount of time by facilitating the process of attaching the faceplate to the guitar body.

1. An electric stringed instrument comprising:
a. a detachable faceplate;
b. an instrument body comprising a bridge and neck comprising machines at its terminal end;
c. a means of releasably attaching the detachable faceplate to the instrument body such that the detachable faceplate may be detached and reattached to the instrument body by hand without the use of tools; and
d. strings attached at one end to the bridge and attached at the other end to the machines.

2. An electric stringed instrument of claim 1 that is an electric guitar.

3. An electric stringed instrument of claim 1 that is an electric bass guitar.

4. An electric stringed instrument of claim 1 wherein the detachable faceplate has a single coil pickup.

5. An electric stringed instrument of claim 1 wherein the detachable faceplate has a Humbucker pickup.

6. An electric stringed instrument of claim 1 wherein the detachable faceplate has more than one coil pickup.

7. An electric stringed instrument of claim 1 wherein the bridge further comprises a tailpiece.

8. An electric stringed instrument of claim 1 wherein the bridge further comprises a vibrato or whammy bar.

9. A method of using an electric stringed instrument of claim 1 comprising the steps of:
a. destringing the strings affixed to the electric stringed instrument;
b. selecting a replacement detachable faceplate;
c. detaching, by hand, the detachable faceplate affixed to the instrument body;
d. affixing, by hand, the replacement detachable faceplate to the instrument body; and
e. restringing the strings.
